(19) United States
(12) Patent Application Publication
(10) Pub. No.: US 2012/0203564 A1
(43) Pub. Date: Aug. 9, 2012

(54) Method and System for Real-Time Automatic Optimization of Emergency Room Resources Management

(75) Inventor: DAVID MYR, Jerusalem (IL)

(73) Assignee: MAKOR ISSUES AND RIGHTS LTD., Jerusalem (IL)

(21) Appl. No.: 13/020,022

(22) Filed: Feb. 3, 2011

(51) Int. Cl. G06Q 10/00; G06Q 50/00

(52) U.S. Cl. 705/2

(57) ABSTRACT

The invention discloses a computer implemented method and system for real-time optimal management of hospital's Emergency Room resources. The system provides optimal work plan for crewmembers and equipment, taking into consideration relevant variables. It uses multivariable optimization techniques to optimize the defined cost functions, which represent overall patient treatment waiting time and cost. Real-time information is provided to both patients and crewmembers. The work plan is continuously updated according to occurring events.

### FIELD OF THE INVENTION

The present invention relates generally to the field of healthcare management. More particularly, the present invention relates to method and system for automatic real time optimal management of emergency room resources.

### BACKGROUND OF THE INVENTION

According to the latest data, there are thousands of emergency rooms worldwide. In 2009, there were 1,800 emergency rooms in the USA alone, with over 90 million recorded visits. Most emergency rooms are exceedingly busy.

Specialized trained personnel, advanced equipment, highly efficient drugs and special-purpose disposable devices contribute to the success of critical care delivery. Thus, the cost of providing good emergency services is very high. Another criterion for the measurement of the quality of service provided by the emergency room is customer turnaround time. A 2008 patient survey found that an average emergency rooms waiting time was about 3 hours.

Therefore, reduction in service cost as well as reduction of patient waiting time is called for. Given the equipment, drugs and personnel, the only way to achieve these goals is by the optimal use of the available emergency room resources.

This includes optimal use of both the crews as well as of the equipment. Such a system should manage automatically and dynamically the resources to get optimal performance. An objective of such optimization is to provide a professionally competent level of healthcare in the shortest time to incoming patients, using the available equipment while minimizing the cost.

An emergency room requires different equipment and different approaches than most other hospital departments. Inflow of patients is unpredictable. Several arriving patients are in life threatening conditions and have to be urgently treated. Thus preplanning, which works for other hospital departments, such as operation rooms, is not practical for the emergency room. Therefore, real time management system is required for the emergency room.

Various approaches, to cope with the need to improve the quality of service and reduce the cost of providing emergency room services, have been developed.

In U.S. Pat. No. 7,691,059 Bulat suggested a system and method for delivering medical examination, treatment and assistance over a network. The patient is not required to come to the physician but rather to communicate with him via audio-visual communication link. However, this approach cannot replace the services given in an emergency room and is applicable only to small percentage of the patients looking for help. Hence, practically, it will not reduce the number of patients visiting the emergency room.

In U.S. Pat. No. 7,451,096 Rucker discloses a system and method for managing healthcare communication. It assumes that the healthcare personnel waists much time in communication of information to/from patients and between crewmembers themselves.

DelMonego, in U.S. Pat. No. 7,562,026 titled “Healthcare procedure and resource scheduling system”, discloses automatic resource monitoring system which can help the medical staff. Albeit, it does not prepare optimal work plan nor does it copes with special emergency room requirements.

Another similar prior art citation is Keck's US patent application 20030050794 titled “Hospital emergency department resource utilization and optimization system”. Keck discloses a system for optimization of reimbursement of hospital expenditures keyed to insurance company policies. The system allows hospital administrators to monitor the cumulative activity of a given department over a period and assess staff and administrative efficiency. It also provides a method for tracking activity and resource utilization within a hospital emergency department. The system does not manage the operations in real time, but rather it collects data in real time. This data can be analyzed aftermath and used by the managerial staff to plan and modify procedures.

In his US patent application 20090125337 titled “Method and System for Management of Operating-Room Resources”, Arbi discloses a method for automatic, real time automatic planning of Operation Room work plan, where the plan is optimized according to specific hospital strategy, such as utilization of the operation room. This is a preplanning procedure rather than real time management. Thus, it does not cope with emergency room specific issues.

Mahesh, in U.S. patent application Ser. No. 10/997,317 titled: “System and method for real-time medical department workflow optimization” describes a system for real-time workflow management in a healthcare environment. Unlike our invention, it offers no real objective-function based optimization and it does not address specific emergency room issues.

Additionally, there are number of patents describing data gathering and emanating systems for hospital environment. For example, Bocionek in his U.S. Pat. No. 6,551,243, discloses a system that collects medical information from multiple sources and organizes it in a suitable way to be accessed by healthcare personnel for use in clinical (e.g., critical) care delivery. The system includes a communication interface for receiving information from patient monitoring devices and for bidirectional communication with a hospital information database containing patient records.

All those factors have to be taken into consideration and therefore development of real-time automated optimized system for emergency room management is of high importance.

### SUMMARY OF THE INVENTION

A system and method for real time, optimal management of emergency room (ER) resources work plan is described. The system continuously monitors all the activities in the ER and updates the work plan. Information on the current and future tasks is automatically sent to all crewmembers as well as to the waiting patients.

The system keeps data on all available resources at each time. This includes data on equipment, personnel and medicines. It also keeps information on standard medical procedures. This data is comprised of a list of resources (equipment, personnel, consumables) required for the execution of the procedure, list of tasks and their order for carrying out the procedure and its estimated duration.

The work plan is updated whenever a new patient is registered into the system, when a new task us added or when the system itself detects deviation from the last work plan that is in force—called the Operative Work Plan (OWP).

The system accumulates data on the executed medical procedures and tasks, and it uses this data to update its own estimates of procedures and task durations.

Information is entered into the system and can be modified only by authorized people. The system can communicate with the patients via plurality of communication channels, such as voice call, sms (short message service), mms, internet, etc. During registration, the user indicates his most convenient communication channel. The information given to a patient (one who is capable of getting it or to his/her companion) comprises data on the next procedure he/she has to go through, its location and its expected starting time and duration. The information sent to the personnel includes the next task to perform, the name of the patient and it estimated starting time. More, comprehensive, information can be viewed by the patient or their companion in data kiosks spread around the hospital. A patient is identified by a smart card that he gets upon registration. Crewmembers can access the data by using their workers identity cards.

The optimization takes into consideration the condition of the patient, i.e. the urgency level of the patient and his arrival time. It optimizes the various activities to minimize overall patient waiting time in the ER and to minimize treatment total cost.

The system enables a user to perform sensitivity analysis, without interruption to its real time operation, to find the most crucial resource that limits the quality of service provided by the ER.

### BRIEF DESCRIPTION OF THE DRAWINGS

FIG. 1 presents the structure of one embodiment of the invented system;

FIG. 2 illustrates the contents of the database of the system.

FIG. 3 depicts general flow diagram of the invented system;

FIG. 4 presents the triggering of the optimization event.

### DETAILED DESCRIPTION

The present invention describes an optimal system and method for the management of Emergency Room (ER) resources. The invention will be described more fully hereinafter, with reference to the accompanying drawings, in which preferred embodiment of the invention is shown. The invention may, however, be embodied in many different forms and should not be construed as limited to the embodiment set forth herein; rather this embodiment is provided so that the disclosure will be thorough and complete, and will fully convey the scope of the invention to those skilled in the art.

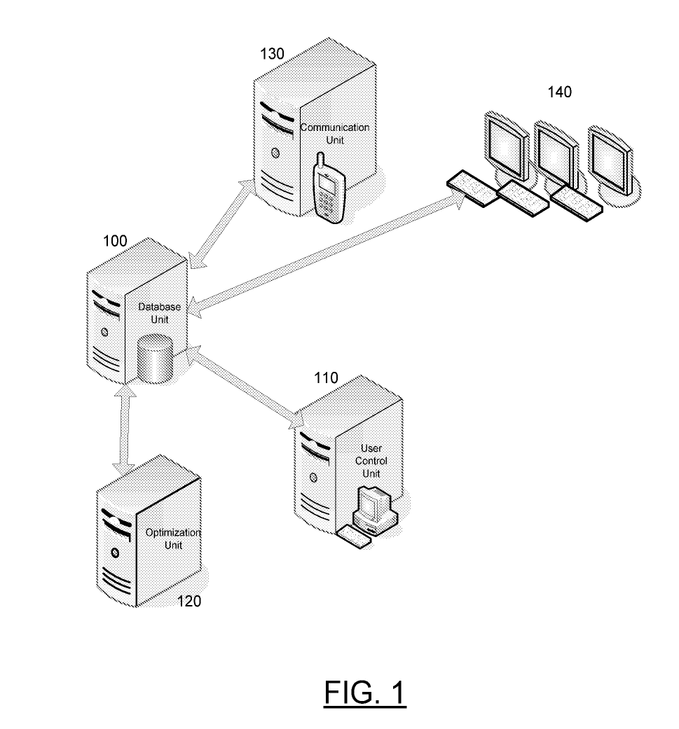

The structure of one embodiment of the invented system is shown in FIG. 1. At the heart of the system is a Database Unit (DBU)—100 connected operatively to all other system elements. The database stores all user and equipment input data and retrieves data requested by other system elements. User input data is entered via the User Control Unit (UCU) 110. The UCU is operatively connected to the DBU. The Optimization Unit (OU) 120, operatively connected to the DBU, retrieves relevant information from the DBU, and executes the resource optimization algorithm the result of which is the optimal work plan stored back into the DBU. The Communication Unit (CU) 130, operatively connected to the DBU, is responsible for sending relevant data over wireless networks and the internet, to patients and to crewmembers. A Display Unit (DU), 140, operatively connected to the DBU, displays relevant information on screens in the Emergency Room.

As mentioned earlier, the configuration shown in FIG. 1 represents only one embodiment of the invention. The functions and methods described hereafter can be implemented in different systems configurations.

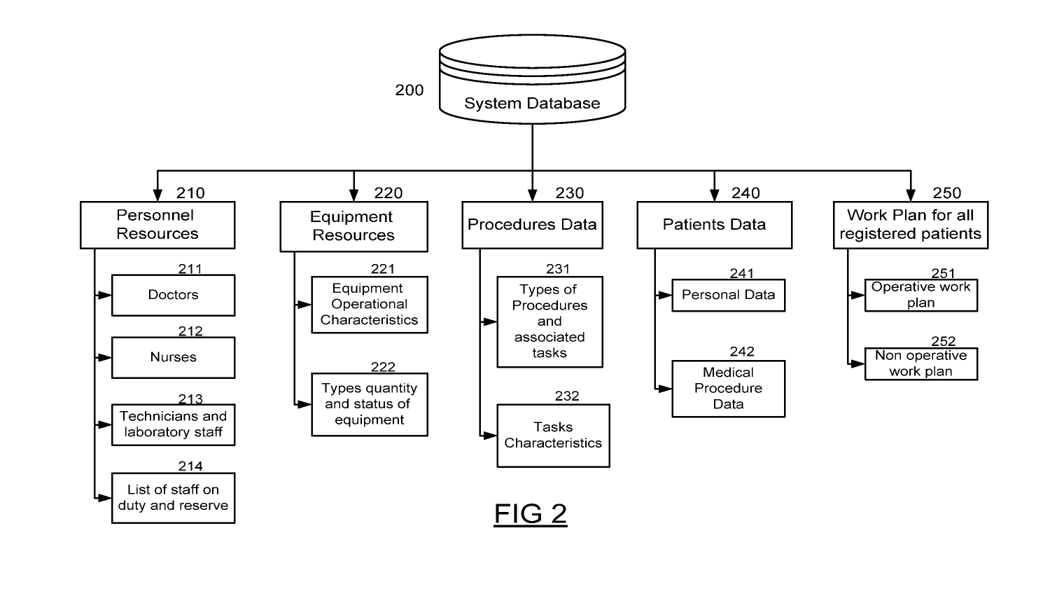

FIG. 2 presents, diagrammatically, the contents of the database. It stores information on resources, medical procedures and patient's data. The information stored is used by the optimization process. User's access to the information in the database is restricted. The Database administrator can grant viewing access and modification privileges to authorized users. The database provides adequate access to the system's components, such as to the optimization algorithm unit, the display unit, the communication unit etc.

The term “task”, as used hereafter, refers to any basic medical operation that requires a defined minimal set of resources and conditions for its execution. It produces a defined outcome and on the average takes a predefined time to execute. This term refers to atom operations.

The term “procedure”, as used hereafter, refers to a sequence of tasks that have meaningful medical result.

For example, blood test is a procedure comprised of two consecutive tasks. The first of which is taking the blood—a task that requires a nurse or a doctor (according to local regulations), followed by analysis task, which requires competent technician and laboratory facilities. The first check-up of a new arriving patient, is a procedure comprised of several tasks, such as fever measurement, blood pressure and heart rate testing etc. The procedures are defined either by a doctor or by a nurse.

The term “treatment”, as used hereafter, refers to a sequence of all procedures for a patient until he leaves the ER. The treatment is usually comprised of analysis procedures followed by curing procedures.

We further define the term “procedure capacity” for a specific procedure, as the number of the procedures that can be carried out simultaneously.

The database—200 keeps information on the ER personnel—210. The data includes, as minimum, information on the specialization of the ER doctors—211 (cardiologists, orthopedists, surgeons, etc.), the specialization of the ER nurses—212, data on technicians (such as X-ray operators and laboratory workers)—213 and information on the availability of these crew members—214 i.e. their work hours schedule for, at least the next 24 hours as well as the on duty personnel.

The database stores information on equipment resources—220 comprised of the relevant characteristics of the equipment—221 and their operational status. The database keeps information on the various medical procedure—230 that can be carried out in ER. It contains, as a minimum, a list of all procedures—231 and tasks that are involved and the characteristics of each task—232, such as required resources for the task and its expected duration and cost.

Information on the patients is also stored in the database—240. It contains, as a minimum, personal data—241 and a record on all scheduled and executed procedures assigned to each patient—242.

The database keeps the generated work plans—250. It stores the operative work plan—251, i.e. the work plan according to which the ER is currently operating. It also keeps historical data on operative work plans, and stores non-operative temporary work plans—252.

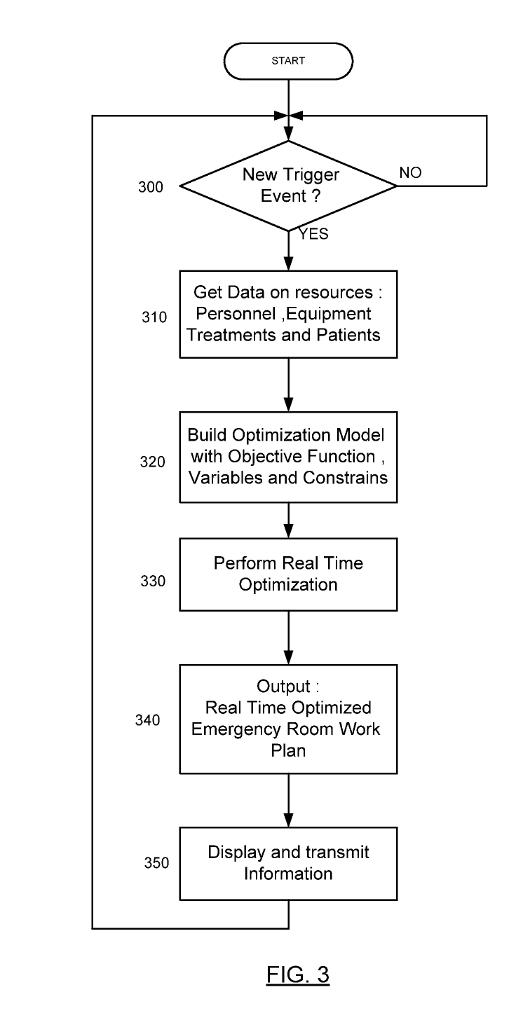

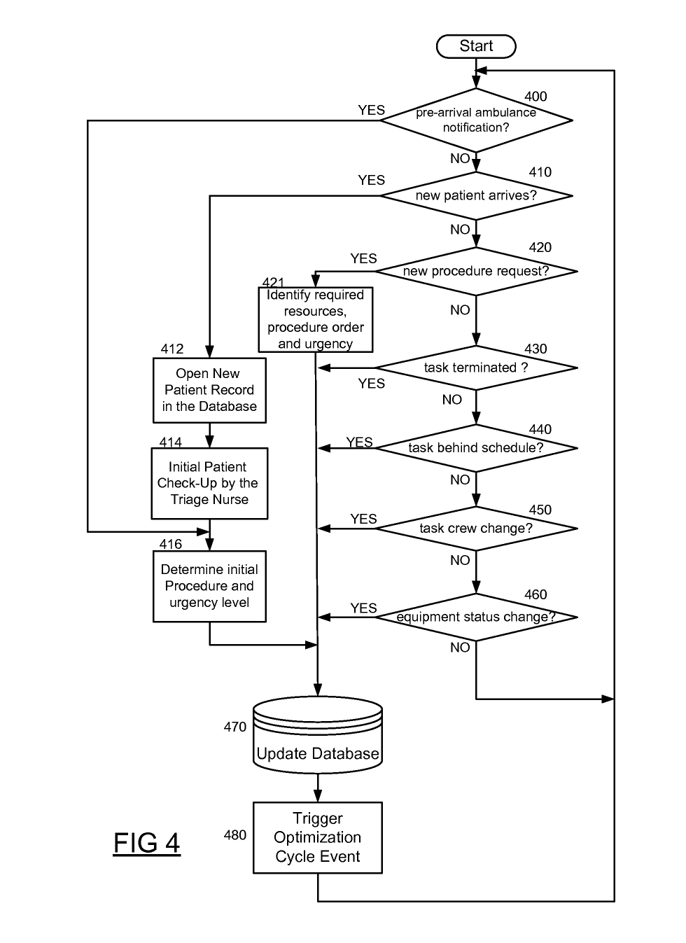

FIG. 3 represents a general process flow. Initially, the database is loaded with information on the resources. This is done during system setup, prior to its ongoing use. From this point on, it functions as an event driven system. The triggering of the event is described in FIG. 4, and will be detailed later on.

The system waits for an event, as shown in step 300 of FIG. 3. When a new event is detected, it proceeds to step 310, where the relevant data from the database is read. It includes data on ER resources and on the registered patients. After the data is obtained, an optimization model is built—step 320. On this model, the real time optimization is performed—step 330. The result of the optimization algorithm is an optimized ER work plan—step 340. This work plan is stored back in the database. The relevant information is transmitted to the personnel and to the patients—step 350.

As explained before, optimization cycle is executed whenever optimization event is triggered. In FIG. 4, the generation of optimization event triggering is presented.

The events that can trigger the optimization event are: pre-arrival ambulance notification—step 400, arrival of a new patient—step 410, request for a new procedure—step 420, termination of a task defined in the work plan—step 430, a delay in the planned execution of a task—step 440 change in available personnel—step 450 or change in availability of equipment—step 460.

When an ambulance was called to an emergency case, he can, prior to arrival, notify the ER of the expected arrival time and provide initial information on the case. If this happens, as tested in step 400 the initial procedures are determined—step 416 after which the database is updated—step 470 and the optimization event is triggered—step 480. Full patient registration is done after patient's arrival.

When a new patient arrives, he/she usually signs up at the reception desk and a new record in the DB is opened. The record is comprised of administrative information and medical data. Administrative information includes, as a minimum, patient name, address, contact data and registration time. Medical information comprises general health condition, allergies, used medications etc,—step 412. After registration a triage nurse—step 414, checks up the new patient and determines—step 416, the initial procedures and the urgency level for that patient.

There are cases where the arriving patient is in a critical condition. In these cases, a medical crew immediately treats the patient. However, updating of the work plan will be done only after the patient's record is opened and initial treatment information is entered into the system. The information is updated in the DB—step 470, and the optimization event is triggered—step 480.

In case of a new treatment or procedure request—step 420, the resources required for its execution are identified and the order of the procedures is defined—step 421. The information is updated in the DB—step 470 and the optimization event is triggered—step 480.

In all other cases, i.e. task termination—step 430, task behind schedule—step 440, crew change—step 450 and equipment status change—step 460, the information is updated in the DB—step 470 after which the optimization event is triggered—step 480.

### Optimization

In this section, detailed description of one embodiment of the optimization algorithm is given. The details given enable a skilled person in the art to implement the invention, using known hardware and software tools.

We denote by {aⱼ}, j=1, 2, 3, . . . , J patient's arriving time where J stands for the total number of patients currently in the Emergency Room and j represents patient's enrollment order.

We also denote by {pⱼ}, j=1, 2, 3, . . . , J the priority of treating the j^{th} patient, where:

pⱼ=Eⱼ−j, and Eⱼ defines urgency degree of the j^{th} patient. (zero defines a patient with lowest degree of urgency). So if the urgency degree of the j₁^{th} patient equals to the urgency degree of the j₂^{th} patient (i.e. Eⱼ₁=Eⱼ₂) the patient who arrived first will be treated earlier.

We also denote by {tᵢ}, i=1, 2, 3, . . . , |S| the duration of medical procedure i.

We define the term “Capacity” of procedure as the maximal number of similar procedures that could be undertaken simultaneously using available personnel and equipment resources. We use for the notation {cᵢ}, i=1, 2, 3, . . . , |S| to denote the number of patients on which procedure i can be done simultaneously;

We want to take into consideration the monetary cost of each procedure. Accordingly, let us now denote by Cᵢ the monetary cost of treatment i.

Procedures are assigned to patients according to medical staff recommendation requests. We use the notation ∥b_{i,j}∥ where i=1, 2, . . . , S; j=1, 2, . . . , J to denote a variable that gets the value 1 if procedure i is requested for patient j. Otherwise it gets the value 0.

Now we define the order in which the procedures assigned to a patient will be executed. This order, if required, is defined either by a triage nurse or by a doctor. In order to consider it we define the following terms:

Qⱼ represents the number of ordered procedures assigned to patient j.

Rⱼ represents the number of non-ordered procedures assigned to patient j.

Now, we denote a list of pairs in the form of {(procedure name, ordinal number)}, such as (X-ray, 3) (urine test, 5)}.

So, for the j^{th} patient

{(S_{j,1}^{Ord},n₁),(S_{j,2}^{Ord},n₂), . . . ,(S_{j,Qi}^{Ord},n_{Qi})}

Now we define non-ordered procedures. For that, we define for the j^{th} patient the sequence of procedures to be {S_{j,1}^{N}, S_{j,2}^{N}, . . . , S_{j,pj}^{N}}, such as {X-ray, urine test}.

The position of a specific non-ordered procedure, in the queue of non-ordered procedure assigned to the j^{th} patient, is determined by weight r_{j,1}=L_{j,i}tᵢ where L_{j,t} is the number of patients to whom the same procedure i is assigned as non-ordered procedure and with priorities higher than pⱼ.

tᵢ represents the duration medical procedure I obtained from available statistical data.

Detailed algorithm of merging the ordered queue and the non-ordered queue is given below.

For each patient we define the decision variable (t_{i,j}), iεS, jεJ, which represents the unknown starting time for the execution of procedure i on patient j. It is measured, in minutes, from the beginning of the optimization cycle produced for all currently present patients;

We denote by T the maximal reasonable waiting time in which patient j will start procedure i.

T=maxⱼ₌₁^{J}(Σᵢ₌₁^{S}b_{i,j}tᵢ), where b_{i,j}=1 if patient j needs procedure i, and 0 otherwise.

If T is found to be insufficient for the feasible solution by optimization, it means that it value has to be increased in order to enable solution to optimization. The value of T is increased by ΔT until optimization solution is reached. The standard deviation of {tᵢ} can be used for ΔT.

Our goal is to optimize emergency room services in such a way that patients who need urgent care will be treated before non-urgent patients, that patients waiting time will be decreased and to keep overall cost as low as possible.

In accordance with the goals mentioned above, we construct the following objective function to be minimized:

Σⱼ₌₁^{|J|}Σᵢ₌₁^{|S|}t_{i,j}(Cᵢ+wₚPⱼ)

Where

t_{i,j} is the waiting time for patient j to procedure i.

Cᵢ is the monetary cost of treatment i.

Pⱼ is the priority of patient j.

wₚ=max {Cᵢ}ᵢ₌₁^{|S|} is the weight of patient's priority relative to monetary cost of treatment

The model is bound by the following constraints:

1. Priority of patients' constraint
The time interval between the beginning of the same procedure i for two patients j1 and j2 is proportional to the duration of procedure i and to the number of patients, having the same priority, who are waiting for the that procedure. It is also inversely proportional to the “capacity” level of this procedure. This constraint is expressed as:

$${t}_{i , j 1} - {t}_{i , j 2} \geq \cdot \frac{{t}_{i}}{{c}_{i}} Δ {P}_{j 1 , j 2}^{i}$$

Where:

pⱼ₁<pⱼ₂

ΔP_{j1,j2}ⁱ denotes the number of patients are waiting for procedure i and their priority lies between Pⱼ₁ and Pⱼ₂.

2. Order of procedure constraints
Here we determine an order of all procedures assigned to a particular patient. As mentioned above, several of those procedures are arranged by a doctor or a nurse, but others are not ordered initially. For that, we use the following algorithm:
If max{n, i=1, 2, . . . Qⱼ}>Rⱼ+Qⱼ the system generates the following message: “Maximal ordinal number exceeds a total number of procedures for patient j”;
If max{nᵢ, i=1, 2, . . . , Qⱼ}=Qⱼ and nᵢ≠nⱼ then S_{j,n}_{ₖ}₋₁^{Ord} is processed before S_{j,k}^{Ord}.
Now, we sort pairs of ordered treatments according to their ordinal number:

{(S_{j,m1}^{Ord},l₁),(S_{j,m2}^{Ord},l₂), . . . ,(S_{j,mQi}^{Ord},l_{Qi}) so that l₁<l₂< . . . l_{Qi}
At the next step, we compute weights for non-ordered treatments such as:

r_{j,1}^{N}=tᵢL_{j,i}, i=1, 2, . . . , Rⱼ.
Then we sort those treatments according to weights (r_{j,i}^{N},S_{j,i}^{N}), i=1, 2, . . . , Rⱼ in ascending order according to r_{j,i}^{N}.
The sorted list of non-ordered treatments will be:

u_{j,i}^{N}<u_{j,i+1}^{N}, i=1, 2, . . . , Rⱼ−1
Next, we find an ordinal number G_{Min} for ordered and sorted procedures where:

Gₘᵢₙ=min{jₙ;jₙ−jₙ₋₁=Cₙ>1}
On the next step, we get Cₙ−1 non-ordered procedures from the sorted list
{u_{j,i}^{N}}, starting in the beginning of the list (because we sorted them in ascending order).
Ordered procedure G_{Min} a predecessor for the treatment u_{j,1}^{N} which is non-ordered at first, and for the non-ordered procedures uⱼ₂^{N} to u_{j,C}_{ₙ}₋₁ previously not ordered procedures, turn to be the predecessor, i.e. u_{j,1}^{N} is a predecessor for u_{j,2}^{N} and u_{C}_{ₙ}₋₂^{N} is a predecessor for u_{C}_{ₙ}₋^{N}.
On the next step, we find a new value for G_{Min} such that:

G_{Min}=max{G_{Min},jₙ;jₙ−jₙ₋₁=Cₙ>1
At the final step, we remove Cₙ−1 procedures (already ordered, i.e., already have a predecessor) from the beginning of {u_{j,i}^{N}} until all non-ordered procedures are removed.

3. Each patient must get all procedures assigned to him

$$T \geq {t}_{{k}_{sj , j}} - {t}_{{k}_{1} , j} + {t}_{{k}_{sj}} \geq {\sum }_{j = 1}^{\vert S \vert} {t}_{i} {b}_{i , j} , ∀ j ∈ J$$

meaning that time interval between the starting time of the first procedure and the termination of the last procedure must be greater or equal to the total time of all procedures assigned to patient j.

As a result of the optimization, an optimal scheduled list of procedures are generates for each enrolled patient. Thus, the patient becomes gets information on all procedures he has to go through and their order, and the time when each procedure is planned to begin.

A special module detects deviation of the actual executed procedures from the planned optimal schedule. If the detected deviation is larger than a preplanned value, the system modifies the plan to compensate for the deviation.

When a large deviation from the scheduled optimization occurs, it is brought to the attention of the service administrator.

As stated beforehand, the system enables the user to perform sensitivity analysis of the overall treatment time for the present patients versus each procedure resources. This enables the administration to find process bottlenecks and try to overcome them.

For procedure i we define Cᵢ^{Max} as the ratio between the maximal possible capacity and the current capacity. The system sensitivity is performed with respect to Cᵢ^{Max}.

### Constraints for Busy Procedures and for Patient's Inside Service

When the i^{th} patient starts service j, then the value of Cⱼ, the capacity, is decreased by one. In addition, this patient will not be assigned once again to the same procedure. It means that variable t_{i,j} is not included in current input to optimization because its value is known. The patient cannot start the next scheduled procedure, before the previous one ends. Therefore, the constraint for procedure scheduling for one patient is the remaining duration:

D_{i,j}^{R}=tᵢ−(T_{Current}−T_{i,j}^{Start})

Where T_{i,j}^{Start} is the known time when patient j started procedure i.

T_{Current} is the real time when the optimization was run.

If in the ordered assignment of patient j, there exists procedure i+1 that follows procedure i, then the constraint for next procedure will be as follows:

t_{i+1,j}−T_{i,j}^{Start}≧D_{i,j}^{R} where:

t_{t+1,j} is unknown—optimal time for starting procedure i+1 for patient j.

The constraint for procedure scheduling for patient j1 assigned to the same procedure i with lower priority than patient j-th will be as follows:

t_{i,j1}−T_{i,j}^{Start}≧D_{i,j}^{R}+t₂[(ΔP_{j,j2}ⁱ−1)/(Cᵢ−1)] where

t_{i,j1} (unknown) is the optimal time of starting service i for the patient j1.

ΔP_{j,j1}ⁱ is the number of patients assigned to the procedure i with priorities between Pⱼ and Pⱼ₁ (not lower than Pⱼ₁ and not higher than Pⱼ).

Qᵢ denotes capacities of procedures that are ready;

If Qᵢ=0 then procedure i is not included in the optimal schedule;

If the already started procedure i is the last one assigned to patient j, then the constraints for the next procedure are omitted.

### ADDITIONAL EMBODIMENTS OF THE SYSTEM

The system can be adapted to support optimal use of Emergency Rooms of multiple hospitals located in nearby geographical area. According to this embodiment, when an emergency service (like 911 in USA) receives a new ambulance service request—it dispatches an ambulance, the ambulance personnel performs physical examination of the patient and submits the patient data to the Centralized Emergency Service—CES. Then, CES sends a request to all the systems installed in the ER. Each request is comprised of client's location and brief description of the problem. The CES gets responses from the management system installed in the interrogated ER that includes the estimated total time comprised of treatment time and travel time. The ER with the shortest time of arrival is given as an answer.

In another embodiment, the optimal management system continuously updates hospital website, as to its current workload and waiting time for some treatments. This enables each person to check and make the best selection for getting the treatment he needs.

What is claimed is:

1. A computer-implemented method for dynamic optimal work plan management of emergency room resources for providing medical treatments to plurality of patients in which objective function based optimization is performed in real-time, comprising the steps of:
a) establishing an initial emergency room resources database, such database includes data on personnel, equipment, medical procedures—diagnostics and treatments—in particular data on time duration and monetary cost of every procedure;
b) receiving new patients at hospital emergency room, opening a computer file for each new patient and entering personalized data identifying the patient;
c) entering data regarding particular procedures and their order required for the patient following medical examination of the patient;
d) entering data regarding urgency level of the patient;
e) identifying the resources required for execution of the procedures required for the patient as defined in step c;
f) obtaining initial data on availability of the resources of step e;
h) establishing an optimal emergency room operative work plan by performing optimization based on data of the said steps a, c, d, e and f.

2. The method as set forth in claim 1, further comprising the step of:
providing optimized emergency room schedule to personnel on screens available throughout the hospital or through personalized computer devices, such as PDA, cell phone, I-phone or laptop device by the means of any of the following communication methods: local area networks or wide area networks, the Internet or Ethernet as well as wireless or landline telecommunication networks.

3. The method as set forth in claim 1 wherein the data in the data base can be modified by the users.

4. The method as set forth in claim 4 wherein different data entering, editing and deleting privileges are granted to different medical and administrative personnel members by the system administrator.

5. The method as set forth in claim 1 wherein any deviation from the operative work plan is detected.

6. The method as set forth in claim 5 wherein a new optimal work plan is generated upon the detection of the deviation.

7. The method as set forth in claim 1 wherein the time duration of a medical procedure is updated according to the average duration of accumulated actual data gathered on that procedure.

8. The method as set forth in claim 1 further comprising the steps of:
a) preparation of temporary set of resources by a user having proper privilege;
b) generation of a temporary work plan upon command from the privileged user;
c) comparing the temporary work plan to the operative work plan;
d) displaying the comparison results to the privileged user.

9. The method as set forth in claim 1, wherein the optimization is done in real time.

10. A computer system for dynamic optimal work plan management of emergency room resources, the system comprising:
a) input means for loading data on resources, medical procedures and patients and for controlling the operation of the system;
b) database means for storing and retrieving information on resources and the optimized work plan;
c) optimization means, operatively connected to the database means, for the generation of optimal work plan based on the data and parameters retrieved from the database means, and storing said work plan in the database means;
d) communication means, operatively connected to the database means, for sending information and instructions to the relevant people and receiving information from the resources to the database means; and
e) display means, operatively connected to the database means, for displaying data to personnel and patients.

11. The system of claim 10, further comprising means for providing optimized emergency room schedule to patients on screens placed throughout the hospital or through personalized computer devices such as PDA, I-phone or laptop device.

12. The system of claim 10, further comprising plurality of communication means, such as local area networks, wide area networks, the Internet or Ethernet as well as wireless or landline telecommunication networks.

13. The system according to claims 10, providing an input capability to enable emergency room medical personnel to input and to modify patients and resources related data to the central hospital server.

14. The system according to claims 10, further comprising means for granting medical personnel members with different data entering, editing, and deleting privileges.

15. The system according to claims 10, further comprising means for detecting deviations from an initial optimization-based emergency work plan for each patient.

16. The system according to claims 10, further comprising means for performing a new optimized treatments work plan for an individual patient and for the emergency room as a whole in case of detecting deviations of claim 14.

17. The system according to claims 10, further comprising means for producing an updated optimized emergency room work plan by performing perpetual optimization in real-time for each patient after he has received each new treatment.

18. The system of claim 10 further comprising means for optimally determining and updating treatment duration times according to the average statistical time of the treatment recorded most recently.
